(19) United States
(12) Patent Application Publication
(10) Pub. No.: US 2022/0011408 A1
(43) Pub. Date: Jan. 13, 2022

(54) Silicon Waveguide Photodetector For In-Line Power Monitoring

(71) Applicants: Meer Nazmus Sakib, Berkeley, CA (US); Ranjeet Kumar, Milpitas, CA (US); Haisheng Rong, Pleasanton, CA (US); Chaoxuan Ma, Sunnyvale, CA (US)

(72) Inventors: Meer Nazmus Sakib, Berkeley, CA (US); Ranjeet Kumar, Milpitas, CA (US); Haisheng Rong, Pleasanton, CA (US); Chaoxuan Ma, Sunnyvale, CA (US)

(21) Appl. No.: 17/483,894

(22) Filed: Sep. 24, 2021

(51) Int. Cl. G01S 7/481; G01S 7/4863; G02B 6/12

(52) U.S. Cl. CPC G01S 7/4818; G02B 6/12; G01S 7/4863

(57) ABSTRACT

In one embodiment, an apparatus includes: a waveguide formed of a PN junction, the waveguide to propagate optical power, the PN junction having a P region adjacent to an N region; and a silicon monitor photodetector formed of the PN junction and in-line with the waveguide to measure the optical power. The silicon monitor photodetector may further be formed of a P-doped region adjacent to the P region and an N-doped region adjacent to the N region. Other embodiments are described and claimed.

### BACKGROUND

For complex silicon photonic (SiP) integrated circuits (ICs), many power monitors may be present for control and optimization of various functionalities of the IC. For example, in a simple four-channel transmitter, a minimum of eight power monitor photodetectors (MPDs) are used to set and control the bias point of the optical modulators. In some SiP-ICs, MPD's are made of III-V compound semiconductor devices such as Indium Phosphide (InP) photodetectors or Germanium (Ge)-based photodetectors. However, these MPDs increase the area, manufacturing complexity, and cost due to the requirement for III-V or Ge material.

In addition, additional structures such as taps are used to tap optical power from a waveguide and provide it to these MPD's, which can adversely affect performance since tap ratio variabilities limit the accuracy of power measurements. InP and Ge-based detectors require heterogenous integration on silicon, resulting in higher material and process costs, which is exacerbated by waveguide routing that consumes additional chip area. Two photon absorption (TPA)-based p-i-n waveguide power monitors can be used as in-line power monitors and overcome some of the problems with InP or Ge-based MPD's, however, their responsivity is low and nonlinear, limiting dynamic range and usability.

### BRIEF DESCRIPTION OF THE DRAWINGS

FIG. 1 is a cross-sectional view of an apparatus in accordance with an embodiment.

FIG. 2 is a cross-sectional view of an apparatus in accordance with another embodiment.

FIG. 3 is a high level block diagram of a portion of a photonic IC in accordance with an embodiment.

FIG. 4A is a graphical illustration of measured responsivity and photocurrent-to-dark current ratio vs. reverse bias.

FIG. 4B is a graphical illustration of measured responsivity and insertion loss versus silicon monitor photodetector length in accordance with an embodiment.

FIG. 4C is a graphical illustration of response of a silicon monitor photodetector at different optical power levels.

FIG. 5 is a block diagram of a system in accordance with an embodiment.

FIG. 6 is a block diagram of a system in accordance with another embodiment.

### DETAILED DESCRIPTION

In various embodiments, a silicon PN junction waveguide-based photodetector (SiPD) may be provided for use in high speed optical interconnect applications. Such SiPDs can be used as a low-cost alternative to III-V or Ge-based photodetectors, and may be adapted on an integrated silicon photonic IC for use as an in-line MPD. By optimizing the doping in the PN junction of the SiPD's and forming the SiPD's having optimized lengths, these devices may be made to be partially absorptive to enable use as in-line MPD's. Stated another way, the PN junction forms an MPD that is in-line with the waveguide itself. This in-line SiPD acts to convert a relatively small portion of the photons (e.g., 5%) propagating through the waveguide into electrons, from which optical power may be measured. In this way, embodiments may eliminate power taps associated with III-V or Ge MPD's, as these detectors absorb nearly 100% of the light, preventing in-line use. In addition, embodiments may realize higher and linear responsivity/response in comparison to TPA-based silicon photodetectors. As a result, smaller, more reliable power monitoring mechanisms are provided, as compared to more expensive, less accurate power tap-based mechanisms. This is so, as an in-line power monitor may be realized from appropriate sizing (e.g., length and width) and doping of a PN junction of a waveguide.

With embodiments in which SiPDs are fabricated as silicon devices without III-V or Ge materials, more compact devices may be realized, and fabrication may be at a lower cost. In different implementations, the SiPDs can be tailored to specific applications/requirements, leading to lower manufacturing cost and improved device performance, especially for more complex silicon photonic IC's.

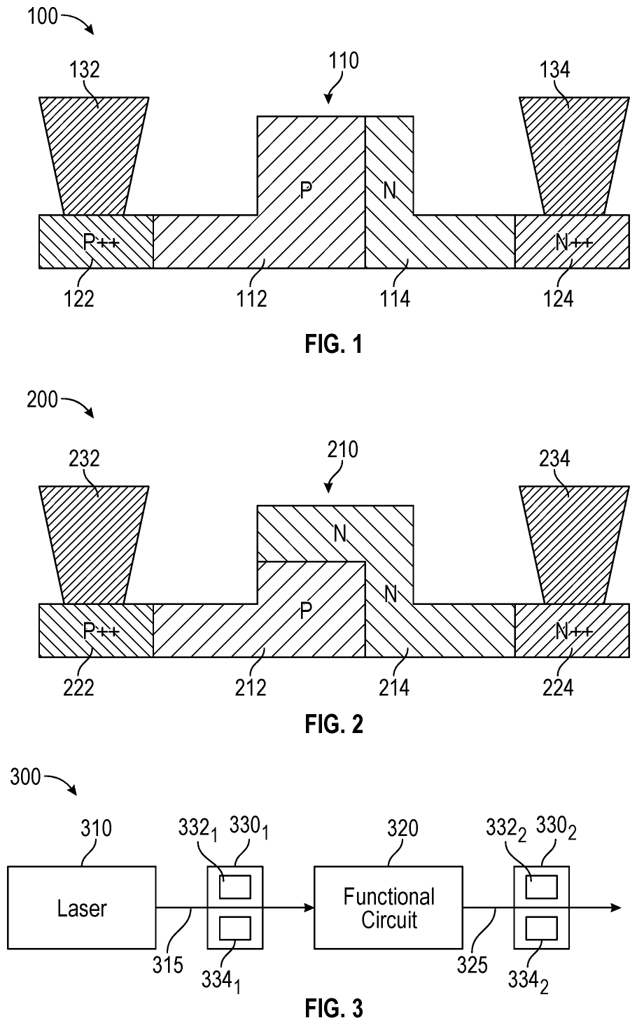

Referring now to FIG. 1, shown is a cross-sectional view of an apparatus in accordance with an embodiment. In the high level view shown in FIG. 1, apparatus 100 may be any type of photonic integrated circuit (PIC) that has an ability to measure optical power using an integrated photodetector in accordance with an embodiment.

As shown, a waveguide 110 is implemented as a so-called rib structure and is formed of a PN junction having a P region 112 and an N region 114. Waveguide 110 may be configured to propagate optical power, e.g., as generated by a given light source such as a laser, light emitting diode (LED) or so forth. Waveguide 110 may be implemented in various locations in a photonic IC. For example, a waveguide may be used to couple different components of the photonic IC, such as a light source and a functional circuit. Although embodiments are not limited in this regard, in a particular example the functional circuit may be a modulator that receives and modulates the optical power. A waveguide also may be adapted at an output of a functional circuit (such as a modulator) and/or on a path between other components.

In any event, to enable in-line optical power monitoring without the need for taps or other couplers that extract or pull off some amount of the optical power, embodiments provide an integrated photodetector. In the embodiment of FIG. 1, this silicon PN junction waveguide-based photodetector (SiPD) may be implemented using highly doped regions adjacent to waveguide structure 110 and providing electrical contacts thereto. More specifically as shown in FIG. 1, the SiPD may be implemented with a highly doped P region 122 adjacent to P region 112 and a highly doped N region 124 adjacent to N region 114. Note that waveguide 110 does not include an intrinsic region, and instead is formed strictly of adjacent P and N regions, which may be lightly doped regions. As further shown, to enable electrical communication of a photocurrent, ohmic contacts 132, 134 may be formed above doped regions 122, 124, respectively.

Understand that while an SiPD may have a given length that may vary based on particular design characteristics, in some embodiments an SiPD may have a length of between approximately 50 and 1000 microns.

Also while implementations may vary, the overall structure of the cross-sectional view in FIG. 1 has lightly doped P region 112 and lightly doped N region 114 that in turn extend outwardly to highly doped N region 122 and highly doped P region 124. In an embodiment, the lightly doped regions may have dopant concentrations of between approximately 1×10¹⁷ to 1×10¹⁸ per cubic centimeter (cm³). Similarly, the highly doped regions may have dopant concentrations of between approximately 1×10¹⁹ to 1×10²⁰ per cm³.

In operation an SiPD may be controlled by a given controller (such as a control circuit of the photonic IC) to be reversed-biased. In some implementations, a reverse bias voltage of approximately −5.0 to −6.0 volts may be applied.

Understand while shown with this particular configuration for use with the waveguide structure in FIG. 1, embodiments may be used in connection with other waveguide structures or other components through which optical power travels.

Referring now to FIG. 2, shown is a cross-sectional view of an apparatus in accordance with another embodiment. In the high level view shown in FIG. 2, apparatus 200 may be another PIC having integrated photodetectors in accordance with an embodiment. In FIG. 2, a different waveguide structure is shown. Waveguide 210 is arranged with an N region 214 that partially overlaps P region 212 (and in fact completely overlaps that portion of N region 212 forming the rib-based portion of waveguide 210). As other components in FIG. 2 may be generally similarly configured the same as apparatus 100 of FIG. 1, reference numerals generally refer to the same components, albeit of the “200” series in place of the “100” series of FIG. 1, and are not further described here.

For a given photonic IC, there may be many locations at which monitoring optical power is desired. Accordingly, SiPDs in accordance with an embodiment can be provided at many different locations within a photonic IC. For example as described above, it may be desirable to measure optical power output by a laser or other light source. In addition it may be desirable to measure optical power at inputs and/or outputs of other components of a photonic IC. As such, a photonic IC can be provided with many SiPDs as described herein that may enable in-line measurement of optical power at many different locations.

Referring now to FIG. 3, shown is a high level block diagram of a portion of a photonic IC in accordance with an embodiment. As shown in FIG. 3, photonic IC 300 includes a laser 310 and a functional circuit 320. As one example, functional circuit 320 may be a modulator that modulates the incoming light from laser 310. As shown, the light generated in laser 310 is provided to functional circuit 320 via a waveguide 315, and similarly the light output by functional circuit 320 is output via another waveguide 325. Waveguides 315, 325 may be implemented as silicon PN junction waveguides as described above with regard to FIGS. 1 and 2. Of course other example waveguide structures such as an undoped passive waveguide instead may be present.

To monitor optical power, a plurality of SiPDs 330_{1,2} are present, respectively at an input of functional circuit 320 and an output of functional circuit 320. Each SiPD 330 is thus directly adjacent to and in-line with a corresponding waveguide, and includes in this top view corresponding ohmic contacts 332 and 334, adapted at opposing sides of waveguides 315, 325. These ohmic contacts may in turn couple to on-chip metal traces that in turn couple to corresponding pads of photonic IC 300 to which bond wires may be connected. Understand while shown at this high level in the embodiment of FIG. 3, many variations and alternatives are possible.

For example in other cases, the laser or other light source may be implemented off-chip and coupled to photonic IC 300 via a fiber optic cable. In some cases, PIC 300 may be a LIDAR sensor or part of a photonic communication system in which optical communications occur via an on-chip transceiver. In turn, an optical fiber may couple multiple PICs to enable high speed optical communication, e.g., within a data center architecture. As examples, a PIC may include multiple transmitters and/or receivers. For example, a PIC may include a 16 or 32-channel transceiver, and can include multiple SiPDs in accordance with embodiment to act as monitor photodetectors (MPDs) for these communication channels. In another use case, a LIDAR sensor may be implemented with as a PIC having a co-packaged photonics engine and a LIDAR device.

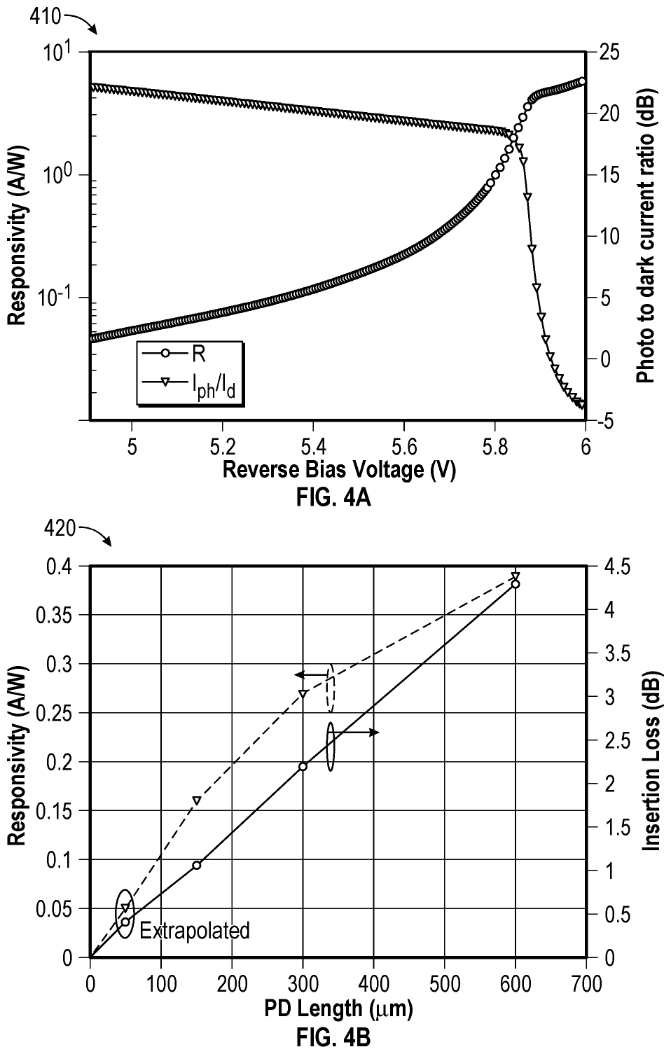

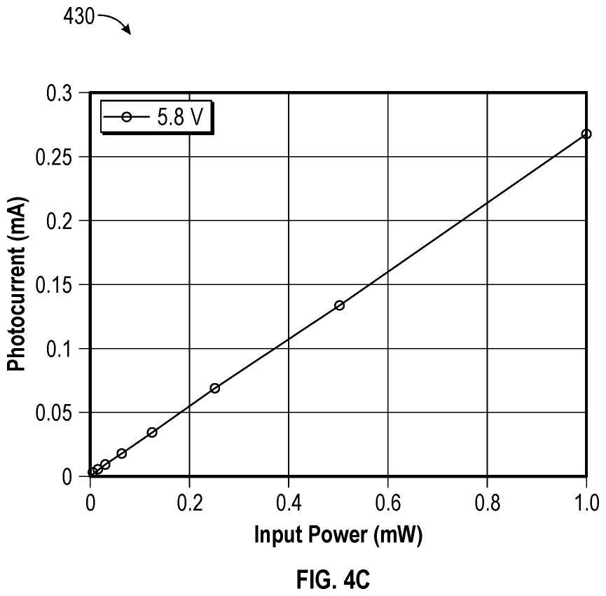

Referring now to FIG. 4A, shown is a graphical illustration of measured responsivity and photocurrent-to-dark current ratio vs. reverse bias for a 300 μm-long SiPD. As shown in curves 410 at a bias voltage of −5.8 volts, a measured responsivity of 0.27 amperes/watt (A/W) results. Curves 410 also show a photocurrent-to-dark current ratio, or signal to noise ratio, of >19 dB at this reverse bias voltage.

With a III-V photodetector implementing a power tap to couple a portion of light out of a waveguide, significant measurement uncertainty may occur due to fabrication variations of the taps and the waveguide transitions that route light to the III-V region having the photodetector. Instead with embodiments, a SiPD absorbs a portion of light that is comparable to the light coupled to the power tap. For example, tapping off 6.0% of light from the main waveguide is equivalent to 0.3 dB of loss in the main waveguide. In addition, there may be about 0.1 dB of scattering loss in the tap coupler due to fabrication imperfection.

Instead with an embodiment, a SiPD having a length of approximately 50 μm long may have an equivalent loss of 0.4 dB or lower. The extrapolated responsivity for a 50 μm-long SiPD is 0.05 A/W, which is equivalent to a III-V PD with a 6.0% tap and is sufficient for power monitoring purposes. Assuming typical responsivity of 0.8 A/W for an InP PD, 1 milliampere (mA) of optical power in the main waveguide will generate photo-current of 48 microamperes (uA) (1 mW×6%×0.8 A/W) in the III-V PD, and 50 uA (1 mW×0.05 A/W) in the in-line SiPD.

FIG. 4B is a graphical illustration of measured responsivity and insertion loss versus SiPD length in accordance with an embodiment, as illustrated in curve 420. In various implementations, the PD length and PN junction design can be engineered to meet desired loss and responsivity requirements for optical power monitoring. The response of the SiPD at different optical power levels as shown in the graphical illustration of FIG. 4C in curve 430 shows good linearity to realize an optimized in-line power monitor.

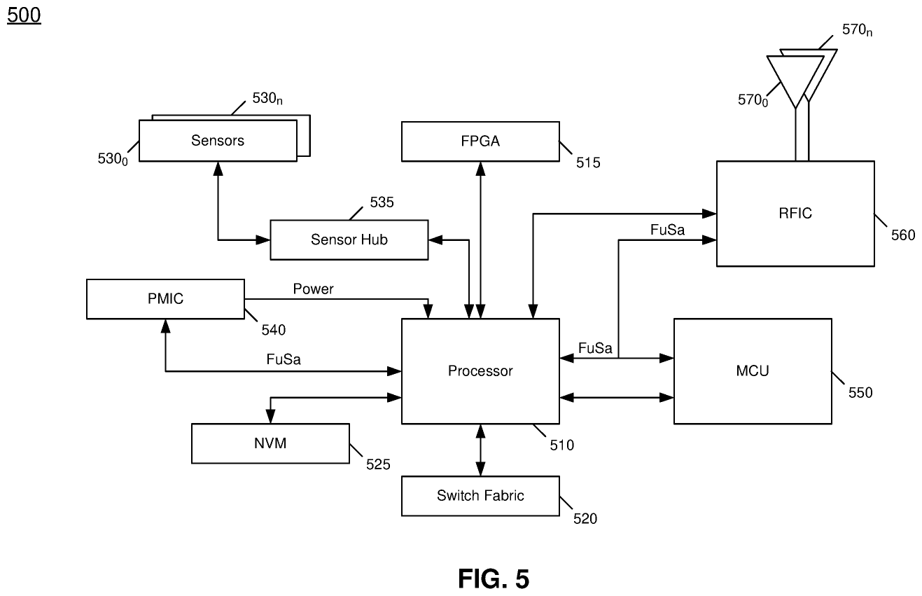

Embodiments may be incorporated into many different system types. Referring now to FIG. 5, shown is a block diagram of a system in accordance with an embodiment. In the embodiment of FIG. 5, system 500 is an autonomous driving computing system. As such, system 500 may be implemented within a vehicle that provides for some level of autonomous driving.

As illustrated, system 500 includes a processor 510, which may be a general-purpose multicore processor or other system on chip (SoC). In different implementations, multiple such processors may be implemented to flexibly allocate autonomous driving workloads across these processors. Processor 510 receives power that is controlled by a power management integrated circuit (PMIC) 540.

System 500 may further include one or more field programmable gate arrays (FPGAs) 515 or other programmable accelerators to which certain autonomous driving workloads may be offloaded. Processor 510 further couples to a non-volatile memory 525, which in an embodiment may be implemented as a flash memory. To provide communication with other components within a vehicle, processor 510 further couples to a switch fabric 520 which in an embodiment may be implemented as an Ethernet switch fabric that in turn may couple to other components within a vehicle, including display components, vehicle infotainment systems, and so forth.

Still further, processor 510 (and switch fabric 520) also couple to a microcontroller (MCU) 550 which may be involved in functional safety testing. Furthermore, to enable interaction with other systems, including other vehicles, roadway systems, over-the-air update sources, infotainment content sources, sensor data communication and so forth, processor 510 and MCU 550 may couple to one or more radio frequency integrated circuits (RFICs) 560.

In embodiments, RFIC 560 may be configured to support 5G-based specifications for communication of automotive and other data via a variety of wireless networks. To this end, RFIC 560 may couple to one or more antennas 570₀-570ₙ of a vehicle.

As further illustrated in FIG. 5, system 500 may include a plurality of sensors 530₀-530ₙ that provide sensor information, via a sensor hub 535 to processor 510. Although embodiments are not limited in this regard, such sensors may include one or more LIDAR sensors, and which may be formed of packages having a PIC including one or more SiPDs to enable in-line optical power monitoring as described herein.

In some cases, system 500 may include a rotating LIDAR sensor to monitor an entire vicinity. In other cases, there may be multiple LIDAR sensors, each fixed to monitor a given direction and field of view. These LIDAR sensors may provide image feedback information to processor 510, which may determine a location (e.g., range, and potentially speed) of an object based at least in part on the image feedback information.

Additional sensors may include ultrasound, radar and optical sensors, among other sensor types. Sensor hub 535 may be configured to fuse at least some of this data to provide information regarding the vehicle's surroundings including object detection, range and speed information, for provision to processor 510. In turn, processor 510 and/or FPGA 515 may use this fused sensor information in connection with performing autonomous driving workloads. Understand while shown at this high level in the embodiment of FIG. 5, many variations and alternatives are possible.

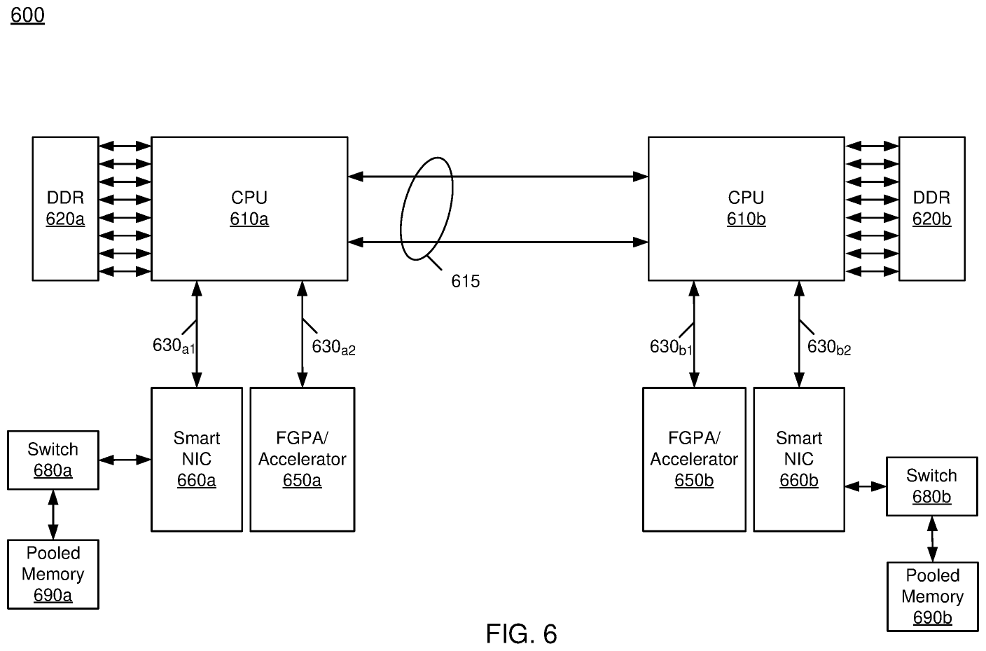

Embodiments may be used in other systems, such as in connection with optical transceivers that couple together via optical fibers, such as may be present in a datacenter environment. Referring now to FIG. 6, shown is a block diagram of a system in accordance with another embodiment. As shown in FIG. 6, a system 600 may be any type of computing device, and in one embodiment may be a server system that is part of a datacenter. In the embodiment of FIG. 6, system 600 includes multiple central processing units (CPUs) 610a,b that in turn couple to respective system memories 620a,b which in embodiments may be implemented as double data rate (DDR) memory. Note that CPUs 610 may couple together via an interconnect system 615, which in an embodiment can be an optical interconnect that communicates with optical circuitry (which may be included in or coupled to CPUs 610) including optical transceivers having PICs including one or more SiPDs to enable in-line optical power monitoring as described herein.

To enable coherent accelerator devices and/or smart adapter devices to couple to CPUs 610 by way of potentially multiple communication protocols, a plurality of interconnects 630a1-b2 may be present. In an embodiment, each interconnect 630 may be a given instance of a Compute Express Link (CXL) interconnect.

In the embodiment shown, respective CPUs 610 couple to corresponding FPGAs/accelerator devices 650a,b (which may include graphics processing units (GPUs), in one embodiment. In addition CPUs 610 also couple to smart network interface circuit (NIC) devices 660a,b. In turn, smart NIC devices 660a,b couple to switches 680a,b that in turn couple to a pooled memory 690a,b such as a persistent memory. Note that any of the interconnects shown may be implemented as optical fibers that couple to optical transceivers incorporating embodiments.

The following examples pertain to further embodiments.

In one example, an apparatus includes: a waveguide formed of a PN junction, the waveguide to propagate optical power, the PN junction having a P region adjacent to an N region; and a silicon monitor photodetector formed of the PN junction and in-line with the waveguide to measure the optical power, the silicon monitor photodetector further formed of a P-doped region adjacent to the P region and an N-doped region adjacent to the N region.

In an example, the silicon monitor photodetector further comprises a first ohmic contact coupled to the P-doped region and a second ohmic contact coupled to the N-doped region.

In an example, the silicon monitor photodetector has a length of less than approximately 1000 microns.

In an example, the waveguide is coupled between a laser and a modulator, the silicon monitor photodetector comprising an in-line power monitor to measure the optical power at an input of the modulator.

In an example, the silicon monitor photodetector is to provide a linear response to the optical power, the silicon monitor photodetector directly adjacent to the waveguide without interposition of a tap.

In an example, the laser, the modulator, the waveguide and the silicon monitor photodetector are formed on a semiconductor die.

In an example, the apparatus further comprises a first conductive trace to couple the first ohmic contact to a first pad of the semiconductor die and a second conductive trace to couple the second ohmic contact to a second pad of the semiconductor die.

In an example, at least one of the N-doped region and the P-doped region has a dopant concentration of between approximately 1×10¹⁹ to 1×10²⁰ per cubic centimeter, the N-doped region and the P-doped region comprising highly doped regions and the N region and the P region comprising lightly doped regions.

In an example, the waveguide comprises a rib structure formed of the PN junction.

In an example, in the rib structure, the N region at least partially covers the P region.

In an example, the apparatus further comprises a control circuit to provide a reverse bias voltage to the silicon monitor photodetector.

In another example, a method comprises: propagating optical power through a waveguide formed of a PN junction having a P region adjacent to an N region, the waveguide formed on a PIC; and measuring the optical power using a silicon monitor photodetector formed of the PN junction and in-line with the waveguide, the silicon monitor photodetector further comprising a P-doped region adjacent to the P region and an N-doped region adjacent to the N region.

In an example, the method further comprises sending a photocurrent detected by the silicon monitor photodetector to a circuit via a first ohmic contact coupled to the P-doped region and a second ohmic contact coupled to the N-doped region.

In an example, the method further comprises: generating the optical power in a laser; measuring the optical power using the silicon monitor photodetector in-line with the waveguide adapted on a path between the laser and a functional circuit; and measuring second optical power using a second silicon monitor photodetector in-line with a second waveguide, the second silicon monitor photodetector formed of a second PN region, the second waveguide coupled to an output of the functional circuit.

In an example, the method further comprises measuring the second optical power of a modulated optical signal output by the functional circuit, the functional circuit comprising a modulator.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises a PIC having: a first waveguide formed of a PN junction, the first waveguide to propagate first optical power, the PN junction having a P region adjacent to an N region; and a first silicon monitor photodetector formed of the PN junction and in-line with the first waveguide to measure the first optical power, the first silicon monitor photodetector further comprising a P-doped region adjacent to the P region and an N-doped region adjacent to the N region; a modulator coupled to the first waveguide, the modulator to modulate the first optical power with a modulated signal to output a modulated optical signal; a second waveguide to communicate the modulated optical signal; and a second silicon monitor photodetector in-line with the second waveguide to measure second optical power of the modulated optical signal. The system may further include a transceiver coupled to the second waveguide to output the modulated optical signal.

In an example, the first waveguide comprises a rib structure formed of the PN junction.

In an example, the system further comprises a control circuit to provide a reverse bias voltage to the first silicon monitor photodetector, the first silicon monitor photodetector having a linear response to a power level of the first optical power.

In an example, the system comprises a photonic communication system further comprising an optical fiber coupled between the photonic integrated circuit and a second photonic integrated circuit.

In an example, the system comprises a LIDAR sensor.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a waveguide formed of a PN junction, the waveguide to propagate optical power, the PN junction having a P region adjacent to an N region; and
a silicon monitor photodetector formed of the PN junction and in-line with the waveguide to measure the optical power, the silicon monitor photodetector further formed of a P-doped region adjacent to the P region and an N-doped region adjacent to the N region.

2. The apparatus of claim 1, wherein the silicon monitor photodetector further comprises a first ohmic contact coupled to the P-doped region and a second ohmic contact coupled to the N-doped region.

3. The apparatus of claim 1, wherein the silicon monitor photodetector has a length of less than approximately 1000 microns.

4. The apparatus of claim 1, wherein the waveguide is coupled between a laser and a modulator, the silicon monitor photodetector comprising an in-line power monitor to measure the optical power at an input of the modulator.

5. The apparatus of claim 4, wherein the silicon monitor photodetector is to provide a linear response to the optical power, the silicon monitor photodetector directly adjacent to the waveguide without interposition of a tap.

6. The apparatus of claim 4, wherein the laser, the modulator, the waveguide and the silicon monitor photodetector are formed on a semiconductor die.

7. The apparatus of claim 6, further comprising a first conductive trace to couple the first ohmic contact to a first pad of the semiconductor die and a second conductive trace to couple the second ohmic contact to a second pad of the semiconductor die.

8. The apparatus of claim 1, wherein at least one of the N-doped region and the P-doped region has a dopant concentration of between approximately 1×10¹⁹ to 1×10²⁰ per cubic centimeter, the N-doped region and the P-doped region comprising highly doped regions and the N region and the P region comprising lightly doped regions.

9. The apparatus of claim 1, wherein the waveguide comprises a rib structure formed of the PN junction.

10. The apparatus of claim 9, wherein in the rib structure, the N region at least partially covers the P region.

11. The apparatus of claim 1, further comprising a control circuit to provide a reverse bias voltage to the silicon monitor photodetector.

12. A method comprising:
propagating optical power through a waveguide formed of a PN junction having a P region adjacent to an N region, the waveguide formed on a photonic integrated circuit (PIC); and
measuring the optical power using a silicon monitor photodetector formed of the PN junction and in-line with the waveguide, the silicon monitor photodetector further comprising a P-doped region adjacent to the P region and an N-doped region adjacent to the N region.

13. The method of claim 12, further comprising sending a photocurrent detected by the silicon monitor photodetector to a circuit via a first ohmic contact coupled to the P-doped region and a second ohmic contact coupled to the N-doped region.

14. The method of claim 12, further comprising:
generating the optical power in a laser;
measuring the optical power using the silicon monitor photodetector in-line with the waveguide adapted on a path between the laser and a functional circuit; and
measuring second optical power using a second silicon monitor photodetector in-line with a second waveguide, the second silicon monitor photodetector formed of a second PN region, the second waveguide coupled to an output of the functional circuit.

15. The method of claim 15, further comprising measuring the second optical power of a modulated optical signal output by the functional circuit, the functional circuit comprising a modulator.

16. A system comprising:
a photonic integrated circuit comprising:
a first waveguide formed of a PN junction, the first waveguide to propagate first optical power, the PN junction having a P region adjacent to an N region; and
a first silicon monitor photodetector formed of the PN junction and in-line with the first waveguide to measure the first optical power, the first silicon monitor photodetector further comprising a P-doped region adjacent to the P region and an N-doped region adjacent to the N region;
a modulator coupled to the first waveguide, the modulator to modulate the first optical power with a modulated signal to output a modulated optical signal;
a second waveguide to communicate the modulated optical signal; and
a second silicon monitor photodetector in-line with the second waveguide to measure second optical power of the modulated optical signal; and
a transceiver coupled to the second waveguide to output the modulated optical signal.

17. The system of claim 16, wherein the first waveguide comprises a rib structure formed of the PN junction.

18. The system of claim 16, further comprising a control circuit to provide a reverse bias voltage to the first silicon monitor photodetector, the first silicon monitor photodetector having a linear response to a power level of the first optical power.

19. The system of claim 16, wherein the system comprises a photonic communication system further comprising an optical fiber coupled between the photonic integrated circuit and a second photonic integrated circuit.

20. The system of claim 16, wherein the system comprises a LIDAR sensor.
